(19) United States
(12) Patent Application Publication
(10) Pub. No.: US 2025/0269759 A1
(43) Pub. Date: Aug. 28, 2025

(54) REPLACEABLE BATTERY FIXING STRUCTURE

(71) Applicant: TOYOTA JIDOSHA KABUSHIKI KAISHA, Aichi-ken (JP)

(72) Inventor: Kiyoshi HOKAZONO, Toyota-shi (JP)

(21) Appl. No.: 19/062,009

(22) Filed: Feb. 25, 2025

(30) Foreign Application Priority Data
Feb. 28, 2024 (JP) 2024-028262

(51) Int. Cl. B60L 53/80; H01M 50/204; H01M 50/249; H01M 50/264; H01M 50/271

(52) U.S. Cl. CPC B60L 53/80; H01M 50/204; H01M 50/249; H01M 50/264; H01M 50/271

(57) ABSTRACT

A replaceable battery fixing structure includes a housing, and a lid that opens and closes an opening of the housing, and a fixing mechanism that fixes the lid to the housing. The housing includes a first inclined surface on an upper back portion of an interior thereof against which an upper corner portion of the replaceable battery abuts, and the lid includes a plurality of second inclined surfaces that abut a lower portion of a proximal end of the replaceable battery. The first inclined surface is inclined downward toward the back, and the second inclined surface is inclined forward toward the bottom.

### CROSS REFERENCE TO RELATED APPLICATION

This application claims priority to Japanese Patent Application No. 2024-028262 filed on Feb. 28, 2024, which is incorporated herein by reference in its entirety including the specification, claims, drawings, and abstract.

### TECHNICAL FIELD

This disclosure relates to the fixing structure of replaceable batteries and the structure of battery-powered vehicles in which replaceable batteries are installed.

### BACKGROUND

JP2022-539061A discloses a battery-powered vehicle that is equipped with replaceable batteries that can be easily attached and removed. JP 2022-539061A also discloses a configuration in which multiple replaceable batteries are housed within the housing attached to the vehicle.

### SUMMARY

When a plurality of replaceable batteries are accommodated in a housing attached to a vehicle, the accommodated replaceable batteries need to be fixed to the housing. In the case of a structure in which the replaceable battery is inserted into the housing in the horizontal direction, a structure in which the replaceable battery is fixed in the horizontal direction by a bolt or the like is often used.

In this case, the fixing force of the upper and lower parts of the replaceable battery is small, and the fixing of the replaceable battery may be insufficient. In addition, the fixing operation using the bolt takes a long time, and the replacement time of the replaceable battery may become long.

Accordingly, an object of the present disclosure is to facilitate attachment and detachment of a replaceable battery and to improve a fixing force of the replaceable battery.

A replaceable battery fixing structure of this disclosure includes a housing that houses a plurality of replaceable batteries in an interior of the housing and includes an opening through which the plurality of replaceable batteries are inserted into the interior of the housing, and a lid that opens and closes the opening, the lid comprising a closing surface that closes the opening, and a fixing mechanism that fixes the lid to the housing. The housing includes a plurality of first fixing surfaces at an upper back portion of the interior of the housing, each of the plurality of first fixing surfaces being configured to abut an upper corner portion of a distal end of each of the plurality of replaceable batteries when each of the plurality of replaceable batteries is inserted into the interior of the housing, the upper back portion of the interior of the housing and the distal end of each of the plurality of replaceable batteries located remote from the opening of the housing. The lid includes a plurality of second fixing surfaces at a lower portion of the closing surface, the plurality of second fixing surfaces being configured to abut a lower portion of a proximal end of each of the plurality of replaceable batteries inserted into the interior of the housing when the opening is closed, the proximal end adjacent to the opening of the housing. Each of the plurality of first fixing surfaces is inclined downward toward a back end of the interior of the housing, the back end of the interior located remote from the opening of the housing. Each of the plurality of second fixing surfaces is inclined forward toward a bottom of the interior of the housing, the forward being toward a front end of the interior of the housing. When the lid is fixed to the housing by the fixing mechanism, each of the first fixing surfaces presses downward the upper corner portion of the distal end of each of the plurality of replaceable batteries in a forward oblique direction, and each of the plurality of second fixing surfaces presses downward the lower portion of the proximal end of each of the plurality of replaceable batteries in a backward oblique direction.

Thus, the replaceable battery can be simultaneously fixed in the insertion direction into the housing and the vertical direction. In addition, the plurality of replaceable batteries can be fixed to the housing by a common fixing mechanism. This facilitates the attachment and detachment of the replaceable battery and improves the fixing force of the replaceable battery.

A replaceable battery fixing structure of this disclosure further may include one or both of a plurality of first elastic members and a plurality of second elastic members. Each of the plurality of first elastic members may be attached to the upper corner portion of the distal end of each of the plurality of replaceable batteries and abuts each of the plurality of first fixing surfaces. Each of the plurality of second elastic members may be attached to the lower portion of the proximal end of each of the plurality of replaceable batteries and abuts each of the plurality of second fixing surfaces.

Thus, the fixing force of the replaceable battery can be further improved. In addition, it is possible to suppress displacement of the position of the replaceable battery with respect to the housing due to vibration.

The fixing mechanism of a replaceable battery fixing structure of this disclosure may include a hook provided on a side surface of the housing, and an operation lever rotatably attached to an outer surface of the lid, and a connector connected to the operation lever at a position between a rotation center of the operation lever and an operation end of the operation lever which is at the other end of the operation lever opposite the end with the rotation center. With the opening of the housing being closed by the lid, the lid may be fixed to the housing by rotating the operation lever toward the lid to engage the tip of the connector with the hook such that the hook is pulled to the front side.

As described above, since the fixing mechanism has a structure that does not include bolt fastening, the attachment/detachment operation of the replaceable battery can be easily performed, and the attachment/detachment time of the replaceable battery to/from the battery-powered vehicle can be shortened.

A battery electric vehicle of this disclosure includes a vehicle body, and a housing that is attached to the vehicle body, houses a plurality of replaceable batteries in an interior of the housing, and includes an opening through which the plurality of replaceable batteries are inserted into the interior of the housing, and a lid that opens and closes the opening, the lid comprising a closing surface that closes the opening, and a fixing mechanism that fixes the lid to the housing. The housing is attached to the vehicle body such that the opening faces a vehicle side surface, and includes a plurality of first fixing surfaces at an upper back portion of the interior of the housing, each of the plurality of first fixing surfaces being configured to abut an upper corner portion of a distal end of each of the plurality of replaceable batteries when each of the plurality of replaceable batteries is inserted into the interior of the housing along a vehicle width direction from the opening, the upper back portion of the interior of the housing and the distal end of each of the plurality of replaceable batteries located remote from the opening of the housing. The lid includes a plurality of second fixing surfaces at a lower portion of the closing surface, the plurality of second fixing surfaces being configured to abut a lower portion of a proximal end of each of the plurality of replaceable batteries inserted into the interior of the housing when the opening is closed, the proximal end adjacent to the opening of the housing. Each of the first fixing surfaces is inclined downward toward a back end of the interior, the back end of the interior located remote from the opening of the housing. Each of the plurality of second fixing surfaces is inclined forward toward a bottom of the interior, the forward being toward a front end of the interior. When the lid is fixed to the housing by the fixing mechanism, each of the first fixing surfaces presses downward the upper corner portion of the distal end of each of the plurality of replaceable batteries in a forward oblique direction, and each of the plurality of second fixing surfaces presses downward the lower portion of the proximal end of each of the plurality of replaceable batteries in a backward oblique direction.

Thus, the replaceable battery can be simultaneously fixed in the insertion direction into the housing and the vertical direction. In addition, the plurality of replaceable batteries can be fixed to the housing by a common fixing mechanism. In addition, in the battery-powered vehicle, it is possible to easily attach and detach the replaceable battery and to improve the fixing force of the replaceable battery. In addition, the replaceable battery can be attached and detached from the side surface of the battery-powered vehicle.

The lid of a battery electric vehicle of this disclosure may be rotatably attached around a rotation shaft attached to the vehicle body substantially in parallel with a lower side of the opening of the housing. The fixing mechanism of a battery electric vehicle of this disclosure may include a hook provided on an upper portion of a side surface of the housing, and an operation lever rotatably attached to an outer surface of the lid, and a connector connected to the operation lever at a position between a rotation center of the operation lever and an operation end of the operation lever which is at the other end of the operation lever opposite the end with the rotation center.

With the opening of the housing being closed by the lid, the lid may be fixed to the housing by rotating the operation lever toward the lid to engage the tip of the connector with the hook such that the hook is pulled to the front side.

As described above, since the fixing mechanism has a structure that does not include bolt fastening, the attachment/detachment operation of the replaceable battery can be easily performed, and the attachment/detachment time of the replaceable battery to/from the battery-powered vehicle can be shortened.

According to the present disclosure, it is possible to facilitate attachment and detachment of the replaceable battery and to improve the fixing force of the replaceable battery.

### BRIEF DESCRIPTION OF DRAWINGS

FIG. 1 is a right side view of an electric vehicle including a replaceable battery fixing structure according to an embodiment;

FIG. 2 is an elevational cross-sectional view of the electric vehicle including the replaceable battery fixing structure of the embodiment, and is a cross-sectional view taken along line A-A of FIG. 1;

FIG. 3 is a cross-sectional view of the housing and the replaceable battery of the replaceable battery fixing structure of the embodiment, and is a detailed view of a portion B shown in FIG. 2;

FIG. 4 is a cross-sectional view of the housing, the lid, and the replaceable battery of the replaceable battery fixing structure of the embodiment, and is a detailed view of a portion C shown in FIG. 2;

FIG. 5 is a plan view showing a fixing mechanism of the replaceable battery fixing structure of the embodiment.

### DESCRIPTION OF EMBODIMENTS

Hereinafter, a replaceable battery fixing structure 100 according to an embodiment will be described with reference to the drawings. Note that FR, UP, and RH shown in the drawings indicate a front side, an upper side, and a right side of the electric vehicle 200 including the replaceable battery fixing structure 100, respectively. The opposite directions of FR, UP, and RH indicate the rear side, the lower side, and the left side, respectively. Hereinafter, in the case of simply using the front-rear direction, the left-right direction, and the up-down direction, unless otherwise specified, the front-rear direction, the left-right direction, and the up-down direction of the electric vehicle 200 are indicated. The electric vehicle 200 is a battery electric vehicle that runs by driving an electric unit (not shown) with electric power supplied from the replaceable battery 70 charged by an external power source.

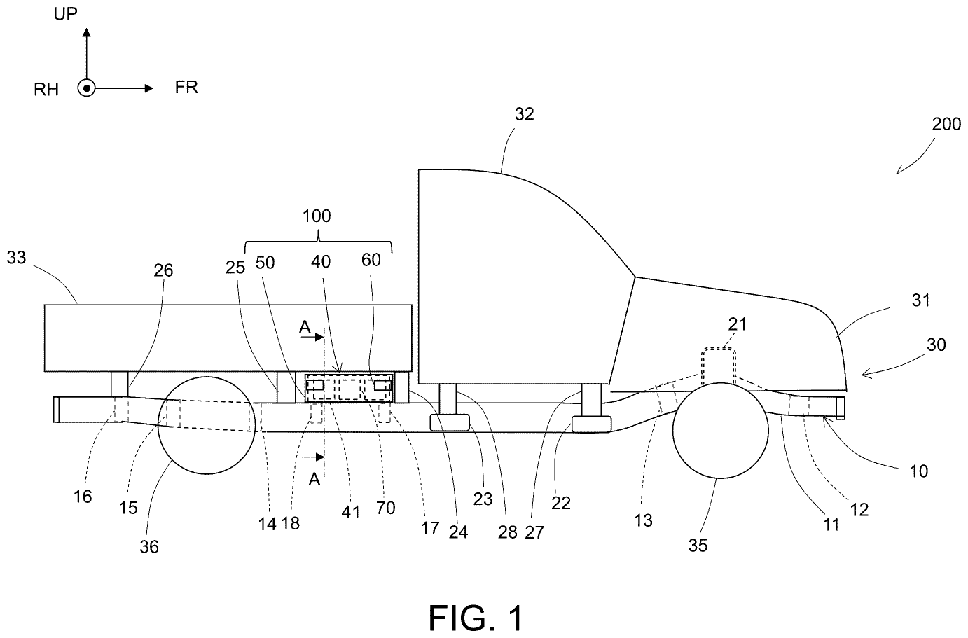

First, a configuration of a vehicle body 30 of an electric vehicle 200 including a replaceable battery fixing structure 100 will be described with reference to FIG. 1. The vehicle body 30 includes a frame 10, a front compartment 31, a cab 32, and a deck 33. The electric vehicle 200 is a frame-type electric truck.

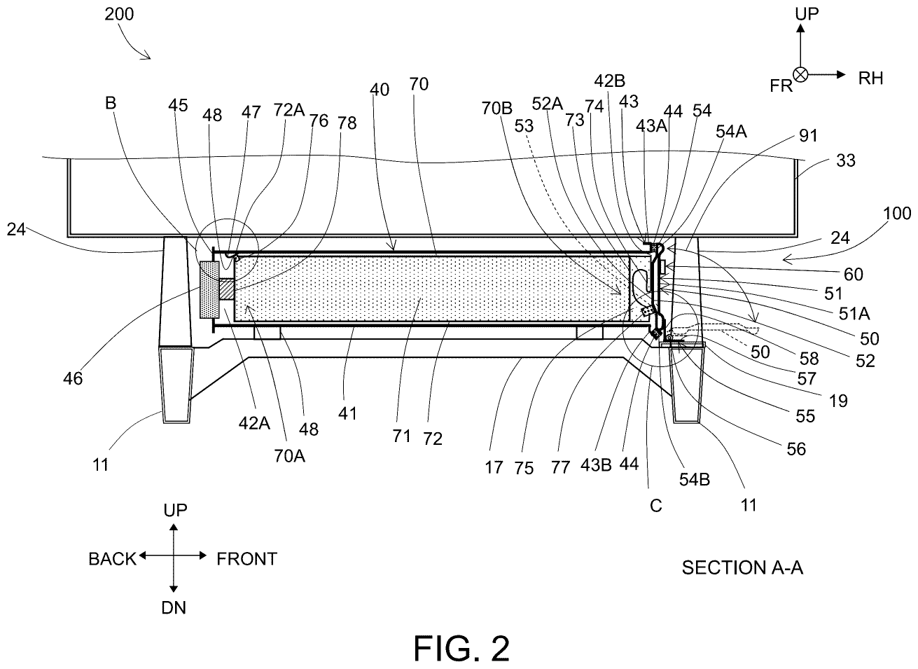

As shown in FIGS. 1 and 2, the frame 10 is a ladder-type frame member including a side rail 11, first to fifth cross members 12, 13, 14, 15, and 16, and first and second battery supports 17 and 18. The first to fifth cross members 12, 13, 14, 15, and 16 are longitudinal members extending in the left-right direction, and connect the left and right side rail 11. The first and second battery supports 17 and 18 are longitudinal members that connect the left and right side rail 11 between the cab 32 and the third cross member 14.

A front suspension bracket 21 is attached to the vehicle width direction outer side of the side rail 11 between the first cross member 12 and the second cross member 13 on the vehicle front side. A suspension device (not shown) for the front wheel 35 is attached to the front suspension bracket 21. A front compartment 31 is disposed in an upper portion between the first cross member 12 and the second cross member 13. A suspension device (not shown) for the rear wheel 36 is attached between the third cross member 14 and the fourth cross member 15 on the rear side of the vehicle.

A front cab mount bracket 22 is attached to the vehicle width direction outer side of the side rail 11 behind the second cross member 13. A front cab mount 27 that supports the front of the cab 32 is mounted on the front cab mount bracket 22. A rear cab mount bracket 23 is attached to the side rail 11 behind the front cab mount 27. A rear cab mount 28 that supports the rear of the cab 32 is mounted on the rear cab mount bracket 23. A first deck mount 24, a second deck mount 25, and a third deck mount 26 are attached to an upper portion of the side rail 11 behind the rear cab mount bracket 23. The first through third deck mounts 24, 25, 26 support the deck 33.

Next, the replaceable battery fixing structure 100 will be described with reference to FIGS. 1 to 4. As shown in FIG. 1, the replaceable battery fixing structure 100 includes a housing 40, a lid 50, and a fixing mechanism 60.

As shown in FIGS. 1 and 2, the housing 40 houses, in the interior 42A, a replaceable battery 70 that is charged by an external power source and supplies power to an electric drive unit (not shown). The housing 40 includes a housing main body 41, an opening 42B, a front flange 43, a back plate 45, a receiving connector 46, and a back bracket 47.

The housing main body 41 is a rectangular longitudinal member having a rectangular closed cross section. The housing main body 41 is attached to the vehicle body 30 so that the opening 42B faces the right side surface of the electric vehicle 200. The right end of the housing main body 41 is a rectangular opening 42B. The left end of the housing main body 41 is closed by a back plate 45. The housing main body 41 houses three replaceable batteries 70 in the interior 42A. The replaceable battery 70 is inserted into the interior 42A from the opening 42B along the vehicle width direction. In the following description, the side on which the opening 42B is disposed is referred to as the front side of the housing 40, and the side away from the opening 42B is referred to as the back side of the housing 40. The insertion end of the replaceable battery 70 into the interior 42A is referred to as a distal end 70A, and the opposite end is referred to as a proximal end 70B. The proximal end 70B is the withdrawal end when the replaceable battery 70 is withdrawn from the interior 42A.

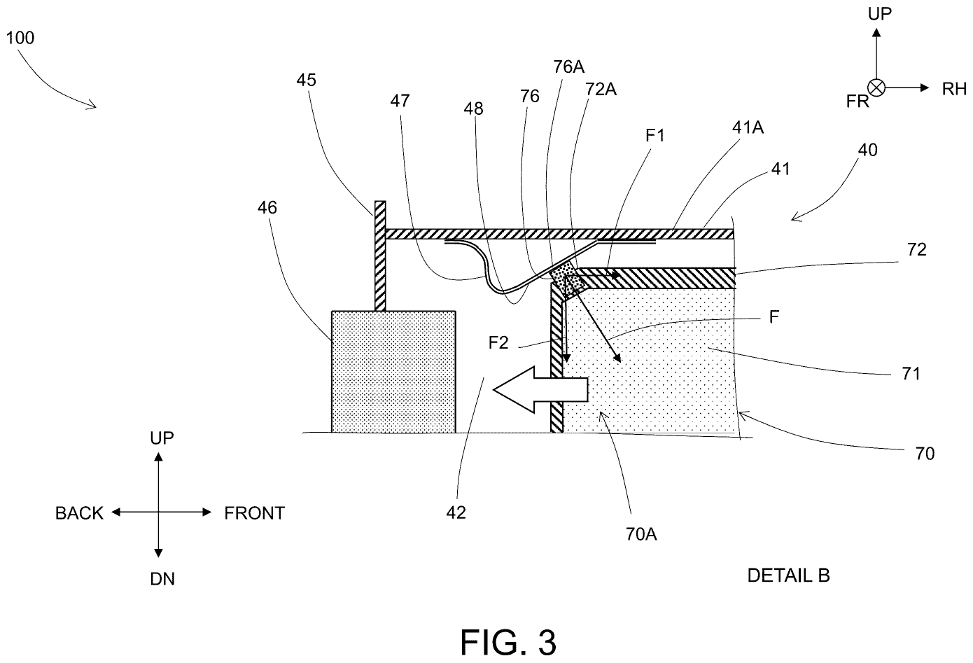

A front flange 43 is attached to a peripheral edge of the opening 42B of the housing main body 41. The front flange 43 includes an upper flange 43A and a lower flange 43B. A packing 44 is set outside the upper flange 43A and outside the lower flange 43B. The back plate 45 is a plate member that closes the back side of the housing main body 41. A receiving connector 46 to which a connector 78 of the replaceable battery 70 is connected is attached to the center of the back plate 45. The receiving connector 46 is connected to an electric unit (not shown). Further, a back bracket 47 is attached to an upper rear portion of the interior 42A of the housing main body 41. Details of the back bracket 47 will be described later with reference to FIG. 3.

The replaceable battery 70 is a longitudinal member having a quadrangular cross section. The replaceable battery 70 includes a battery body 71 that is a combination of a plurality of battery cells, a casing 72 that houses the battery body 71, a connector 78, and a front portion 73. A connector 78 is provided at the distal end 70A of the replaceable battery 70. A first elastic member 76 is attached to the upper corner portion 72A of the distal end 70A of the replaceable battery 70. The first elastic member 76 is made of, for example, rubber, resin, or the like. Details of the upper corner portion 72A and the first elastic member 76 will be described later together with a detailed structure of the back bracket 47 with reference to FIG. 3.

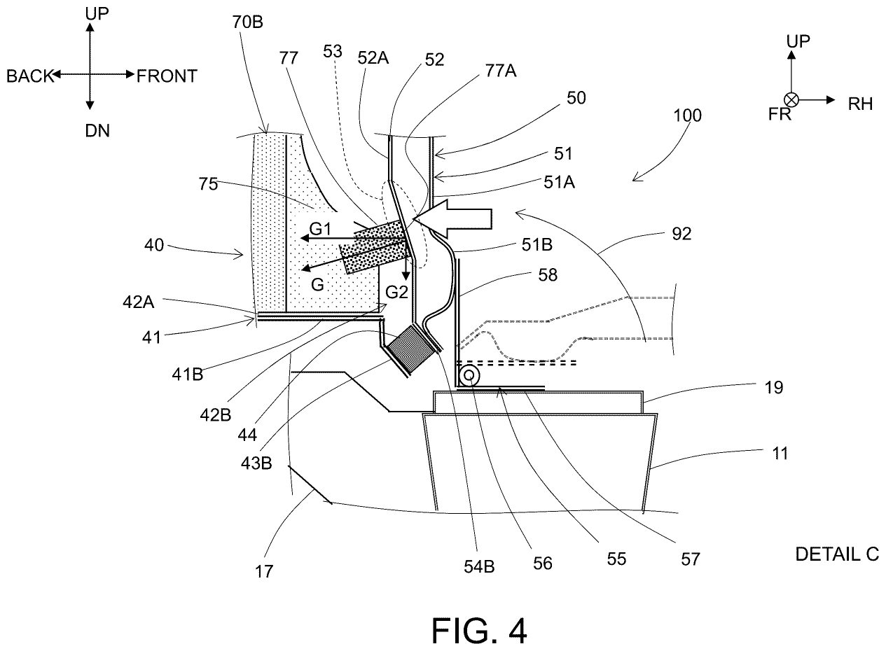

A front portion 73 is attached to the proximal end 70B of the replaceable battery 70. The front portion 73 includes a handle 74 and a lower portion 75. The handle 74 is disposed in a upper portion of the front portion 73. The handle 74 is a portion that is gripped when the replaceable battery 70 is pulled out from the housing 40. The lower portion 75 is disposed at a lower portion of the front portion 73. The lower portion 75 is a portion located near the lower portion of the opening 42B when the replaceable battery 70 is inserted into the interior 42A of the housing 40. A second elastic member 77 is attached to the front side of the lower portion 75. The second elastic member 77 is made of, for example, rubber, resin, or the like. Details of the lower portion 75 and the second elastic member 77 will be described later with reference to FIG. 4.

The lid 50 is rotatably attached to the vehicle body 30 by a hinge 55 attached to the vehicle body 30 substantially in parallel with the lower side of the opening 42B of the housing 40. As indicated by an arrow 91 in FIG. 2 and an arrow 92 in FIG. 4, the lid 50 rotates around the rotation shaft 56 of the hinge 55 to open and close the opening 42B. A lid 50 indicated by a broken line in FIG. 2 shows a state in which the lid 50 is opened, and a lid 50 indicated by a solid line shows a state in which the lid 50 closes the opening 42B.

The lid 50 includes an outer plate 51 and an inner plate 52. The peripheral edge portions of the inner plate 52 and the outer plate 51 overlap each other to form a lid flange 54. The lid flange 54 includes a lid upper flange 54A and a lid lower flange 54B. The packing 44 is sandwiched between the lid flange 54 and the front flange 43 of the housing 40 when the lid 50 closes the opening 42B. An annular bead 51B is provided on the inner peripheral side of the lid flange 54 of the outer plate 51. The bead 51B has a groove-shaped cross-sectional shape protruding outward.

As shown in FIG. 4, the hinge 55 includes a base 57 fixed on the bracket 19 mounted on the right side rail 11, a rotation shaft 56 mounted on the base 57, and a hinge plate 58 rotatably mounted around the rotation shaft 56. The hinge plate 58 is fixed to the outer surface of the bead 51B on the lower side of the lid 50. Thus, the lid 50 is rotatably attached around the rotation shaft 56 of the hinge 55 attached to the vehicle body 30 to open and close the opening 42B.

The inner surface 52A of the inner plate 52 of the lid 50 constitutes a closing surface that faces the opening 42B and closes the opening 42B when the lid 50 closes the opening 42B. A plurality of second inclined surfaces 53, which are set at the lower corner portions 75 of the plurality of replaceable batteries 70 and come into contact with the second elastic members 77 when the lid 50 closes the opening 42B, are provided at a lower portion of the inner surface 52A. Details of the second inclined surface 53 will be described later together with detailed structures of the lower portion 75 and the second elastic member 77 with reference to FIG. 4.

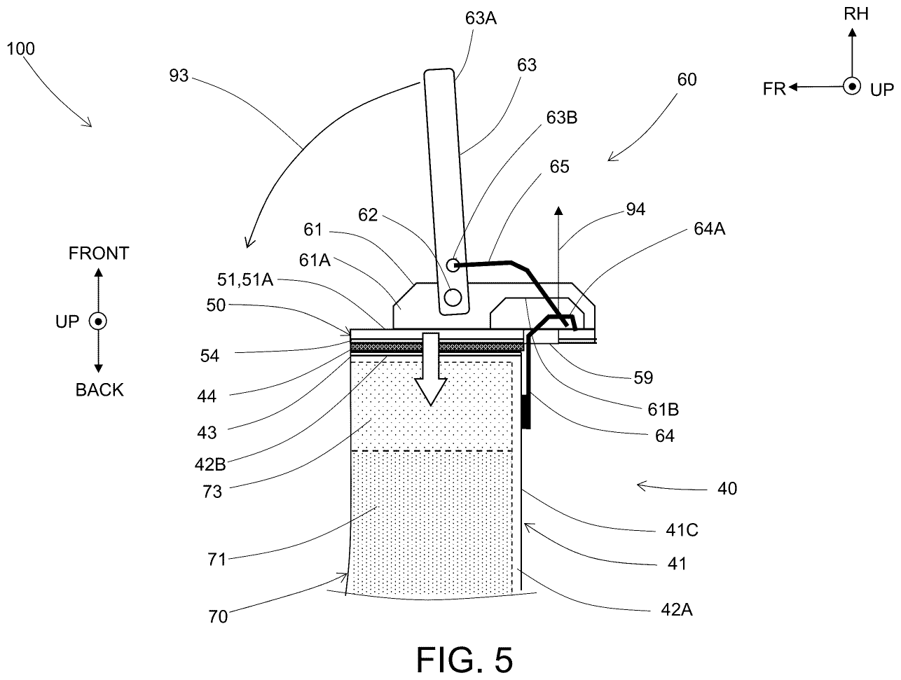

A fixing mechanism 60 for fixing the lid 50 to the housing 40 is provided on an upper portion of the outer plate 51 of the lid 50. Details of the fixing mechanism 60 will be described later with reference to FIG. 5.

Next, the back bracket 47 of the housing 40, the upper corner portion 72A of the replaceable battery 70, and the first elastic member 76 will be described in detail with reference to FIG. 3. As shown in FIG. 3, the back bracket 47, the upper corner portion 72A, and the first elastic member 76 are located away from the opening 42B.

As shown in FIG. 3, the back bracket 47 is attached to the rear portion of the upper plate 41A of the housing main body 41. The back bracket 47 is a mountain-shaped folded plate member, and includes a first inclined surface 48 inclined downward toward the rear of the housing 40.

The upper corner portion 72A of the replaceable battery 70 is the upper corner of the distal end 70A of the casing 72. The first elastic member 76 is attached to the upper corner portion 72A. The upper surface 76A of the first elastic member 76 is inclined downward toward the distal end 70A of the replaceable battery 70. The upper surface 76A of the first elastic member 76 is parallel to the first inclined surface 48 of the back bracket 47. As indicated by white arrows in FIG. 3, when the replaceable battery 70 is inserted into the interior 42A of the housing 40, the upper surface 76A of the first elastic member 76 abuts against the first inclined surface 48 of the back bracket 47. The first inclined surface 48 fixes the upper corner portion 72A of the replaceable battery 70 to the housing main body 41. Accordingly, the first inclined surface 48 is a first fixing surface that fixes the upper corner portion 72A of the replaceable battery 70 to the housing main body 41 when the replaceable battery 70 is inserted into the interior 42A of the housing 40.

When three replaceable batteries 70 are accommodated in the housing main body 41 as in the replaceable battery fixing structure 100 of the present embodiment, a total of three back brackets 47 are provided for each of the replaceable batteries 70.

Next, a detailed structure of the second inclined surface 53 of the lid 50, the lower portion 75 of the replaceable battery 70, and the second elastic member 77 will be described with reference to FIG. 4.

Next, a detailed structure of the second inclined surface 53 of the lid 50, the lower portion 75 of the replaceable battery 70, and the second elastic member 77 will be described with reference to FIG. 4.

When three replaceable batteries 70 are accommodated in the housing main body 41 as in the replaceable battery fixing structure 100 of the present embodiment, a total of three second inclined surfaces 53 are provided for each of the replaceable batteries 70 in the lid 50.

Next, the fixing mechanism 60 will be described with reference to FIG. 5. The fixing mechanism 60 includes a base 61, a hook 64, an operation lever 63, and a connector 65. As shown in FIG. 5, the hook 64 is attached to the side surface 41C of the housing main body 41. The hook 64 is a folded plate member in which a U-shaped engagement claw 64A is formed at a tip end thereof. The base 61 is attached to the outer surface 51A of the outer plate 51 of the lid 50, and the base 61 includes a fixing portion 61A fixed to the outer surface 51A of the outer plate 51 and a guide groove 61B for guiding the connector 65. The operation lever 63 is rotatably attached around the rotation shaft 62 attached to the fixing portion 61A. Here, the center of the rotation shaft 62 constitutes the rotation center of the operation lever 63. The connector 65 is rotatably attached to the hole 63B closer to the operating end 63A than the rotation shaft 62.

Next, closing of the lid 50 and fixing of the replaceable battery 70 will be described. When the lid 50 is closed, the engagement claw 64A of the hook 64 protrudes to the outside of the lid 50 through the through hole 59 provided in the lid 50. Then, the distal end of the connector 65 is engaged with the engagement claw 64A of the hook 64, and the operating end 63A of the operation lever 63 is rotated toward the lid 50 as indicated by an arrow 93 in FIG. 5. Then, the connector 65 moves while being guided by the guide groove 61B, and pulls up the engagement claw 64A of the hook 64 to the front side as indicated by an arrow 94 in FIG. 5. As a result, the packing 44 between the lid flange 54 of the lid 50 and the front flange 43 of the housing 40 collapses, and the lid 50 closes the opening 42B. Then, when the operation lever 63 is rotated until it becomes parallel to the outer plate 51 of the lid 50, the state in which the connector 65 pulls up the hook 64 is held. As described above, when the lid 50 is closed, the lid 50 presses the replaceable battery 70 toward the back of the housing 40 as indicated by the white arrows in FIGS. 3, 4, and 5. When three replaceable batteries 70 are accommodated in the housing main body 41 as in the replaceable battery fixing structure 100 of the present embodiment, when the lid 50 is closed, the lid 50 simultaneously presses the three replaceable batteries 70 toward the back of the housing 40.

As indicated by white arrows in FIG. 3, when the replaceable battery 70 is pressed toward the back of the housing 40, the first elastic member 76 attached to the upper corner portion 72A of the replaceable battery 70 abuts against the first inclined surface 48 of the back bracket 47. Then, the first fixing force F in the vertical direction with respect to the first inclined surface 48 is applied to the upper corner portion 72A via the first elastic member 76. The first fixing force F presses the upper corner portion 72A of the replaceable battery 70 obliquely downward toward the front. Accordingly, a horizontal force F1 for pressing the replaceable battery 70 toward the front side and a downward force F2 for pressing the replaceable battery 70 downward are applied to the replaceable battery 70.

As shown in FIG. 4, when the lid 50 closes the opening 42B, the second inclined surface 53 of the lid 50 contacts the second elastic member 77. Then, the second fixing force G in the vertical direction with respect to the second inclined surface 53 is applied to the lower portion 75 of the replaceable battery 70 via the second elastic member 77. The second fixing force G presses the lower portion 75 of the replaceable battery 70 downward in the diagonally rearward direction. Accordingly, a horizontal force G1 for pressing the replaceable battery 70 toward the back and a downward force G2 for pressing the replaceable battery 70 downward are applied to the replaceable battery 70.

When the lid 50 closes the opening 42B, the replaceable battery 70 is fixed between the back bracket 47 and the lid 50 by the horizontal forces F1 and G1. The replaceable battery 70 is fixed between the bottom plate 41B of the housing main body 41 and the first inclined surface 48 and the second inclined surface 53 by the downward forces F2 and G2.

As described above, the replaceable battery fixing structure 100 can simultaneously fix the replaceable battery 70 in the insertion direction into the housing 40 and in the vertical direction. Thus, the fixing force of the replaceable battery 70 can be improved. Further, by fixing the common lid 50 to the housing 40 by the fixing mechanism 60, it is possible to fix the three replaceable batteries 70 to the housing 40 at one time, and it is possible to shorten the time for attaching and detaching the replaceable batteries 70 to and from the electric vehicle 200.

In addition, since the fixing mechanism 60 includes the base 61, the hook 64, the operation lever 63, and the connector 65 and does not include bolting, it is possible to easily attach and detach the replaceable battery 70. In addition, it is possible to shorten the time for attaching and detaching the replaceable battery 70 to and from the electric vehicle 200.

Further, in the replaceable battery fixing structure 100, since the first elastic member 76 and the second elastic member 77 are provided, the fixing force of the replaceable battery 70 can be further improved. In addition, it is possible to suppress displacement of the position of the replaceable battery 70 with respect to the housing 40 due to vibration.

In addition, in the electric vehicle 200, since the housing 40 is attached to the vehicle body 30 so that the opening 42B faces the vehicle side surface, the replaceable battery 70 can be attached and detached from the side surface of the electric vehicle 200.

In the above description, the replaceable battery 70 includes the first elastic member 76 in the upper corner portion 72A and the second elastic member 77 in the lower portion 75, but may include only one of the first elastic member 76 and the second elastic member 77. When the upper corner portion 72A does not include the first elastic member 76, the first inclined surface 48 of the back bracket 47 abuts on the upper corner portion 72A. Similarly to the upper surface 76A of the first elastic member 76, the upper corner portion 72A may be configured to be parallel to the first inclined surface 48. Similarly, when the lower portion 75 does not include the second elastic member 77, the front surface of the lower portion 75 may be configured to be parallel to the second inclined surface 53 similarly to the front surface 77A of the second elastic member 77.

In the above description, the lid 50 is rotatably attached to the vehicle body 30 by the hinge 55. For example, the lid 50 may be configured to be detachable from the housing 40 without being attached to the vehicle body 30. In this case, the fixing mechanism 60 may be disposed on the upper portion and the lower portion of the lid 50.

In the replaceable battery fixing structure 100, the housing main body 41 is attached to the vehicle body 30 such that the opening 42B is on the right side surface of the electric vehicle 200, but the present disclosure is not limited thereto. For example, the housing main body 41 may be mounted on the vehicle body 30 such that the opening 42B is on the left side surface of the electric vehicle 200. The housing main body 41 may be attached to the vehicle body 30 such that the opening 42B is located behind the electric vehicle 200. In this case, the replaceable battery 70 is inserted in the front-rear direction of the electric vehicle 200.

In the above description, the electric vehicle 200 is described as a frame-type electric truck including the frame 10, the front compartment 31, the cab 32, and the deck 33. The electric vehicle 200 may be a frame-type SUV or an electric vehicle having a monocock body. The electric vehicle 200 may be a bus or the like, or may be a light van.

1. A replaceable battery fixing structure comprising:
a housing that houses a plurality of replaceable batteries in an interior of the housing and includes an opening through which the plurality of replaceable batteries are inserted into the interior of the housing;
a lid that opens and closes the opening, the lid comprising a closing surface that closes the opening; and
a fixing mechanism that fixes the lid to the housing, wherein
the housing includes a plurality of first fixing surfaces at an upper back portion of the interior of the housing, each of the plurality of first fixing surfaces being configured to abut an upper corner portion of a distal end of each of the plurality of replaceable batteries when each of the plurality of replaceable batteries is inserted into the interior of the housing, the upper back portion of the interior of the housing and the distal end of each of the plurality of replaceable batteries located remote from the opening of the housing,
the lid includes a plurality of second fixing surfaces at a lower portion of the closing surface, the plurality of second fixing surfaces being configured to abut a lower portion of a proximal end of each of the plurality of replaceable batteries inserted into the interior of the housing when the opening is closed, the proximal end adjacent to the opening of the housing, each of the plurality of first fixing surfaces is inclined downward toward a back end of the interior of the housing, the back end of the interior located remote from the opening of the housing,
each of the plurality of second fixing surfaces is inclined forward toward a bottom of the interior of the housing, the forward being toward a front end of the interior of the housing,
when the lid is fixed to the housing by the fixing mechanism, each of the first fixing surfaces presses downward the upper corner portion of the distal end of each of the plurality of replaceable batteries in a forward oblique direction, and each of the plurality of second fixing surfaces presses downward the lower portion of the proximal end of each of the plurality of replaceable batteries in a backward oblique direction.

2. The replaceable battery fixing structure according to claim 1, further comprising:
one or both of a plurality of first elastic members and a plurality of second elastic members, wherein
each of the plurality of first elastic members is attached to the upper corner portion of the distal end of each of the plurality of replaceable batteries and abuts each of the plurality of first fixing surfaces, and
each of the plurality of second elastic members is attached to the lower portion of the proximal end of each of the plurality of replaceable batteries and abuts each of the plurality of second fixing surfaces.

3. The replaceable battery fixing structure according to claim 1, wherein
the fixing mechanism includes,
a hook provided on a side surface of the housing,
an operation lever rotatably attached to an outer surface of the lid, and
a connector connected to the operation lever at a position between a rotation center of the operation lever and an operation end of the operation lever which is at the other end of the operation lever opposite the end with the rotation center,
with the opening of the housing being closed by the lid, the lid is fixed to the housing by rotating the operation lever toward the lid to engage the tip of the connector with the hook such that the hook is pulled to the front side.

4. The replaceable battery fixing structure according to claim 2, wherein
the fixing mechanism includes,
a hook provided on a side surface of the housing,
an operation lever rotatably attached to an outer surface of the lid, and
a connector connected to the operation lever at a position between a rotation center of the operation lever and an operation end of the operation lever which is at the other end of the operation lever opposite the end with the rotation center,
with the opening of the housing being closed by the lid, the lid is fixed to the housing by rotating the operation lever toward the lid to engage the tip of the connector with the hook such that the hook is pulled to the front side.

5. A battery electric vehicle comprising:
a vehicle body;
a housing that is attached to the vehicle body, houses a plurality of replaceable batteries in an interior of the housing, and includes an opening through which the plurality of replaceable batteries are inserted into the interior of the housing;
a lid that opens and closes the opening, the lid comprising a closing surface that closes the opening; and
a fixing mechanism that fixes the lid to the housing, wherein
the housing is attached to the vehicle body such that the opening faces a vehicle side surface, and includes a plurality of first fixing surfaces at an upper back portion of the interior of the housing, each of the plurality of first fixing surfaces being configured to abut an upper corner portion of a distal end of each of the plurality of replaceable batteries when each of the plurality of replaceable batteries is inserted into the interior of the housing along a vehicle width direction from the opening, the upper back portion of the interior of the housing and the distal end of each of the plurality of replaceable batteries located remote from the opening of the housing,
the lid includes a plurality of second fixing surfaces at a lower portion of the closing surface, the plurality of second fixing surfaces being configured to abut a lower portion of a proximal end of each of the plurality of replaceable batteries inserted into the interior of the housing when the opening is closed, the proximal end adjacent to the opening of the housing,
each of the first fixing surfaces is inclined downward toward a back end of the interior, the back end of the interior located remote from the opening of the housing,
each of the plurality of second fixing surfaces is inclined forward toward a bottom of the interior, the forward being toward a front end of the interior,
when the lid is fixed to the housing by the fixing mechanism, each of the first fixing surfaces presses downward the upper corner portion of the distal end of each of the plurality of replaceable batteries in a forward oblique direction, and each of the plurality of second fixing surfaces presses downward the lower portion of the proximal end of each of the plurality of replaceable batteries in a backward oblique direction.

6. The battery electric vehicle according to claim 5, wherein
the lid is rotatably attached around a rotation shaft attached to the vehicle body substantially in parallel with a lower side of the opening of the housing,
the fixing mechanism includes:
a hook provided on an upper portion of a side surface of the housing,
an operation lever rotatably attached to an outer surface of the lid, and
a connector connected to the operation lever at a position between a rotation center of the operation lever and an operation end of the operation lever which is at the other end of the operation lever opposite the end with the rotation center,
with the opening of the housing being closed by the lid, the lid is fixed to the housing by rotating the operation lever toward the lid to engage the tip of the connector with the hook such that the hook is pulled to the front side.
